(19) United States
(12) Patent Application Publication
(10) Pub. No.: US 2019/0235734 A1
(43) Pub. Date: Aug. 1, 2019

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventors: Kaori SHIBUYA, Kanagawa (JP); Ryouji TAGUCHI, Kanagawa (JP)

(73) Assignee: FUJI XEROX CO., LTD., Tokyo (JP)

(21) Appl. No.: 16/209,974

(22) Filed: Dec. 5, 2018

(30) Foreign Application Priority Data
Jan. 31, 2018 (JP) 2018-015090

(51) Int. Cl. G06F 3/0484; G06F 3/0486; G06F 3/0481

(52) U.S. Cl. CPC G06F 3/04845; G06F 3/04817; G06F 3/0486

(57) ABSTRACT

An information processing apparatus includes a deformation unit that temporarily deforms a display image indicating a target in response to an operation in a case where a user performs the operation on the target, in which, in a case where the operation is an operation of moving, copying, or deleting the target from a location where the target is originally present on a screen, the deformation unit deforms the display image indicating the target before being operated in a state in which the target remains.

### CROSS-REFERENCE TO RELATED APPLICATIONS

This application is based on and claims priority under 35 USC 119 from Japanese Patent Application No. 2018-015090 filed Jan. 31, 2018.

### BACKGROUND

### (i) Technical Field

The present invention relates to an information processing apparatus and a non-transitory computer readable medium storing an information processing program.

### (ii) Related Art

JP2016-146221A discloses a technique in which, in order to facilitate work for moving a first element to a position of a second element on a display region in which a plurality of elements are displayed, in a case where a detection unit detects a first operation for moving the first element pointed on a display region among elements displayed in the display region on the display region, a movement unit moves the first element on the display region according to the first operation; an extraction unit extracts the second element corresponding to the movement direction of the first element from the elements displayed in the display region; a proximity display unit generates a third element relating to the second element, and displays the third element at a position more adjacent to the first element than to the second element; and an element processing unit performs a process corresponding to a second operation on the second element in a case where the detection unit detects the second operation on the third element.

JP2013-125498A discloses a technique in which, in order to automatically display an region in which temporary interruption of a D and D operation is allowed in a case where a desired storage part may not be found when a file and a folder on an OS is uploaded to a document management application through D and D, a document management device acquires information on a folder hierarchical structure which is managed by a document management server, and displays the folder hierarchical structure in a display region; in a case where a file is dragged for a time exceeding predefined time by a pointing device, a temporary display region is displayed in the display region; in a case where the file is dropped in the temporary display region, information of the file is stored, and an icon of the file is displayed in the temporary display region; and, in a case where the file displayed in the temporary display region is dragged, and dropped at a position where an icon of the pointing device overlaps any of folders included in the folder hierarchical structure, the file is uploaded to the folder on the basis of file information.

JP2007-179095A discloses a technique in which, in order to improve operability of a pointing device when performing drag and drop, in a case where a drag operation in operating a mouse to perform drag and drop is detected, a movement direction of a pointer displayed on a monitor is determined, and it is checked whether or not there is a window in the determined movement direction of the pointer; in a case where there is a window, a current position of the window is acquired, a movement direction and a movement amount are set, and then a display position of the window is moved on the basis of the settings; consequently, by overlapping the pointer on the window, and performing a drop operation, a drag and drop operation of an icon is performed, and then, the display position of the window is returned to the current position.

JP1994-332657A discloses a technique in which, in order to obviate troublesomeness for checking a capacity as a result of enabling a file capacity at the time of moving a file to be sensuously checked, in an information processing apparatus provided with a hard disk having a plurality of file storage regions, a display device for displaying a file with an icon on its screen, a mouse for indicating any location on the screen with a cursor in accordance with a manual operation of the mouse, and also, designating the file displayed by the icon with the cursor, and moving the file to any location on the screen while the cursor is moved, and a control circuit which moves the file by giving a specific delay to a movement of the cursor in accordance with a capacity of the file designated by the cursor, and, consequently, since the icon is moved, and a rough value of the file capacity can be understood, a display checking operation for the file capacity is saved, and thus troublesomeness due to the operation is obviated.

### SUMMARY

A user may perform an unintended operation due to an erroneous operation. For example, in a case where a mouse button is unintentionally released in the middle of a movement operation, a location to which a selected file or folder is moved is not known. On the other hand, there is a system in which the previous operation can be canceled. However, in a case where an originally performed operation or a target on which an operation has been performed is not known, it may not be determined whether or not the previous operation is to be canceled.

Aspects of non-limiting embodiments of the present disclosure relate to an information processing apparatus and a non-transitory computer readable medium storing an information processing program enabling a user to check an operation and a target after the user performs the operation.

Aspects of certain non-limiting embodiments of the present disclosure overcome the above disadvantages and other disadvantages not described above. However, aspects of the non-limiting embodiments are not required to overcome the disadvantages described above, and aspects of the non-limiting embodiments of the present disclosure may not overcome any of the problems described above.

According to an aspect of the present disclosure, there is provided an information processing apparatus including a deformation unit that temporarily deforms a display image indicating a target in response to an operation in a case where a user performs the operation on the target, in which, in a case where the operation is an operation of moving, copying, or deleting the target from a location where the target is originally present on a screen, the deformation unit deforms the display image indicating the target before being operated in a state in which the target remains.

### BRIEF DESCRIPTION OF THE DRAWINGS

Exemplary embodiment(s) of the present invention will be described in detail based on the following figures, wherein:

FIG. 1 is a conceptual module configuration diagram for a configuration example of the present exemplary embodiment;

FIGS. 2A and 2B are diagrams illustrating a system configuration example according to the present exemplary embodiment;

FIG. 3 is a diagram illustrating data structure examples of an operation history management table and an object information management table;

FIG. 4 is a flowchart illustrating a process example according to the present exemplary embodiment;

FIG. 5 is a diagram illustrating a process example according to the present exemplary embodiment;

FIG. 6 is a diagram illustrating a process example according to the present exemplary embodiment;

FIG. 7 is a flowchart illustrating a process example according to the present exemplary embodiment;

FIG. 8 is a diagram illustrating a process example according to the present exemplary embodiment;

FIG. 9 is a flowchart illustrating a process example according to the present exemplary embodiment;

FIG. 10 is a flowchart illustrating a process example according to the present exemplary embodiment;

FIG. 11 is a diagram illustrating a process example according to the present exemplary embodiment;

FIG. 12 is a flowchart illustrating a process example according to the present exemplary embodiment;

FIG. 13 is a diagram illustrating a process example according to the present exemplary embodiment;

FIG. 14 is a flowchart illustrating a process example according to the present exemplary embodiment;

FIG. 15 is a diagram illustrating a process example according to the present exemplary embodiment;

FIG. 16 is a diagram illustrating a process example according to the present exemplary embodiment; and

FIG. 17 is a block diagram illustrating a hardware configuration example of a computer realizing the present exemplary embodiment.

### DETAILED DESCRIPTION

Hereinafter, with reference to the drawings, a description will be made of an exemplary embodiment for realizing the invention.

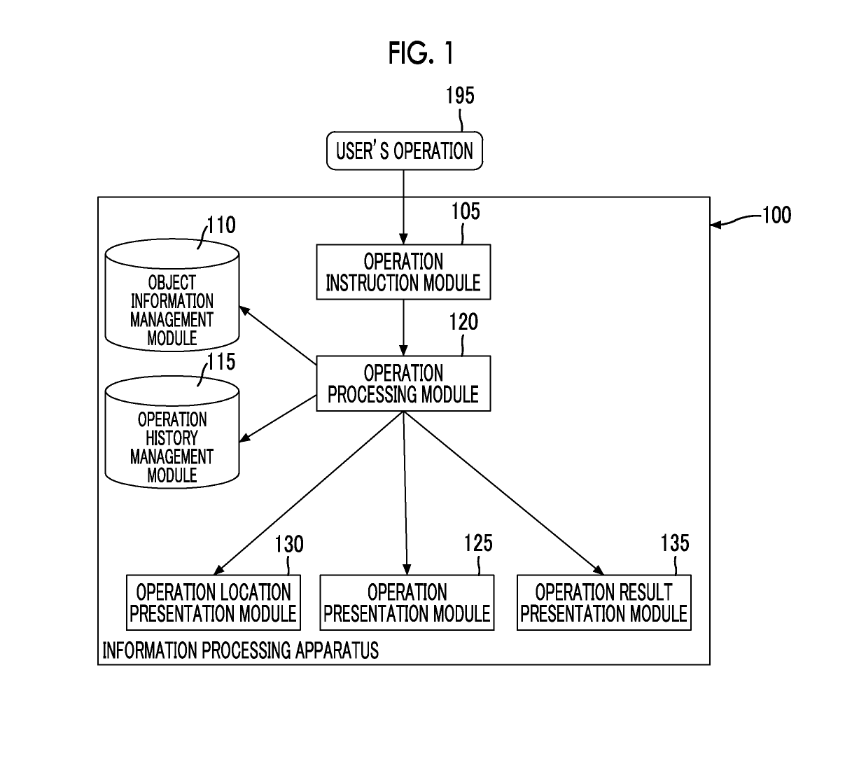

FIG. 1 is a conceptual module configuration diagram illustrating a configuration example according to the present exemplary embodiment.

The module generally indicates components such as software (computer program) or hardware which can be logically divided. Therefore, the module in the present exemplary embodiment indicates not only a module in a computer program but also a module in a hardware configuration. Therefore, in the present exemplary embodiment, a description will also be made of a computer program (a program causing a computer to execute each procedure, a program causing a computer to each unit, or a program a computer to realize each function), a system, and a method for functioning as such a module. However, for convenience of description, “storing”, “being stored”, or words equivalent thereto are used, but, these words indicate that a storage device stores data or a storage device is controlled to store data in a case where an exemplary embodiment is a computer program. A module may correspond to a function on a one-to-one basis, and, in installation, a single module may be configured with a single program, a plurality of modules may be configured with a single program, and, conversely, a single module may be configured with a plurality of programs. A plurality of modules may be executed by a single computer, and a single module may be executed by a plurality of computers in a distributed or parallel environment. Other modules may be included in a single module. Hereinafter, the term “connection” indicates only physical connection but also logical connection (transmission and reception of data, indication, a reference relationship between pieces of data, login, and the like). The term “setting in advance” indicates that setting is performed prior to a target process, and indicates not only that setting is performed before a process according to the present exemplary embodiment is started but also that, even after a process according to the present exemplary embodiment is started, setting is performed depending on a situation or a state at the time or a situation or a state hitherto in a case where a target process is not performed. In a case where there are “a plurality of preset values”, the values may be different from each other, and two or more values may be the same as each other (of course, including all of the values). The description that “in a case of A, B is performed” indicates that “it is determined whether or not A is satisfied, and, in a case where it is determined that A is satisfied, B is performed”. However, this excludes a case where determination of whether or not A is satisfied is unnecessary. In a case where objects are listed such as “A, B, and C”, the objects are exemplarily listed unless otherwise mentioned, and a case where only one thereof (for example, only A) is selected is included.

A system or an apparatus also includes not only a case where a plurality of computers, pieces of hardware, and apparatuses are configured to be connected to each other via a communication unit such as a network (including communication connection on a one-to-one basis) but also a case of being configured with a single computer, a single piece of hardware, and a single apparatus. The “apparatus” and the “system” are used as terms having an identical meaning. Of course, the “system” does not include systems that are merely a social “mechanism” (social system) which is an artificial arrangement.

Target information is read from a storage device, the process is performed, and a process result is written to the storage device for each process performed by each module or for each process in a case where a plurality of processes are performed in a module. Therefore, description of reading for a storage device before a process and writing for the storage device after the process will be omitted. The storage device here may include a hard disk, a random access memory (RAM), an external storage medium, a storage device connected via a communication line, a register in a central processing unit (CPU), or the like.

An information processing apparatus 100 according to the present exemplary embodiment enables a user to check an operation and a target (also referred to as an object), and includes, as illustrated in an example in FIG. 1, an operation instruction module 105, an object information management module 110, an operation history management module 115, an operation processing module 120, an operation presentation module 125, an operation location presentation module 130, and an operation result presentation module 135.

There is a technique of processing a target in response to an operation of a user on a screen. Such an operation includes movement (including drag and drop), copying, and deletion (including cutting). There may be a plurality of targets, but a case where there is a single target will be described and focused.

Process contents of movement, copying, and deletion operations will be described.

The movement operation is an operation of moving a target from an original location to another location on a screen. Therefore, generally, the number of target display images is not changed after the operation on the screen. In a case where there is a single target, the single target remains.

The copying operation is an operation of leaving a target at a location where the target is originally present and transferring a copy of the target to another location on a screen. Therefore, generally, the number of target display images is doubled after the operation on the screen. In a case where there is a single target, two targets are generated after copying.

The deletion operation is an operation of deleting a target from a screen. Therefore, generally, a target display image is removed after the operation on the screen.

In a case where a worker gives an instruction for an unintended movement operation due to an erroneous mouse operation, the following problems may occur.

For example, in a case where a mouse button is unintentionally released in the middle of a movement operation, a location to which a selected file or folder is moved is not known.

For example, in a case where a mouse button is unintentionally pressed in the middle of movement of a cursor, it is not known whether or not a movement operation has been performed, and which file or folder has been moved.

As a result, there is a case where a moved file or folder is lost, and thus is not returned to an original state.

The previous operation can be canceled by performing a special operation (for example, Ctrl+Z) depending on a system, but an operation over a file system may not be canceled. In a case where an originally performed operation is not known, it may not be determined whether or not the previous operation is to be canceled.

The information processing apparatus 100 enables a user to check an operation and a target after the user performs the operation.

A user's operation 195 is an operation indicating an instruction for the information processing apparatus 100, and is a user's operation using, for example, a mouse, a keyboard, a touch panel, a voice, a visual line, and a gesture.

The operation instruction module 105 is connected to the operation processing module 120. The operation instruction module 105 receives the user's operation 195, and instructs the operation processing module 120 to perform a process on a target in response to the operation. The operation instruction module 105 controls, for example, a liquid crystal display functioning as a mouse, a keyboard, and a touch panel, a camera, or a microphone, so as to receive a user's operation (including a mouse operation, a key operation, movement of the finger or a pen on a touch panel, a visual line, a gesture, and a voice).

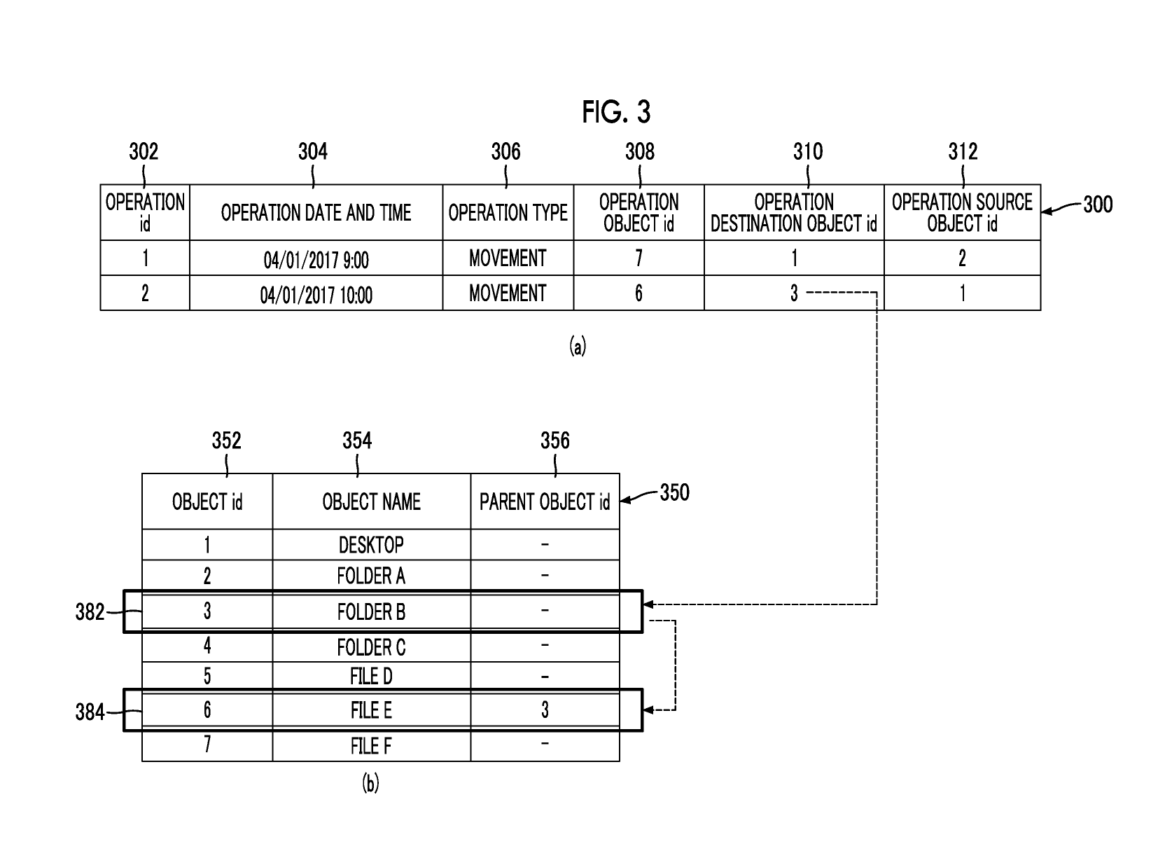

The object information management module 110 is connected to the operation processing module 120. The object information management module 110 stores information regarding a target. The “target” is generally referred to as an object, and is, for example, a file (a document or the like) or a folder. The information regarding a target includes information as the target, and attribute information of the target. This will be described later by using an object information management table 350 illustrated in an example in (b) of FIG. 3.

The operation history management module 115 is connected to the operation processing module 120. The operation history management module 115 stores information regarding a history of an operation. This will be described later by using an operation history management table 300 illustrated in an example in (a) of FIG. 3.

The operation processing module 120 is connected to the operation instruction module 105, the object information management module 110, the operation history management module 115, the operation presentation module 125, the operation location presentation module 130, and the operation result presentation module 135. The operation processing module 120 performs a process on a target in response to an instruction from the operation instruction module 105.

The operation processing module 120 controls the operation presentation module 125, the operation location presentation module 130, and the operation result presentation module 135, and temporarily deforms a display image indicating a target in response to an operation in a case where the user performs the operation on the target.

As the “display image”, there is, for example, an icon indicating the target in a simulation manner, or a thumbnail image of the target. Hereinafter, an exemplified case will be described by using an icon. An operation performed by an operator is performed on an icon indicating a target.

The “deformation” is to deform an original display image (a display image before being operated) into another display image. The “deformation” includes, for example, not only a case where a shape of an original display image is deformed but also a case where a transmittance or a color of the original display image is changed. The “deformation” also includes a case where an icon is added to an original display image or an icon is displayed to overlap the original display image without changing the original display image. The “deformation” may include addition of a letter or a symbol, a dynamic change (for example, flash or animation), blinking (a change target in blinking is whether or not blinking is performed, a period in which blinking is performed, or an interval of blinking), or a combination thereof.

In a case where an operation is an operation of moving, copying, or deleting a target from a location where the target is originally present on a screen, the operation processing module 120 may deform a display image indicating the target before being operated in a state in which the target remains. A “target before being operated” will also be referred to as an “operation source”, and a “target after being operated” will also be referred to as an “operation destination”.

An operation of “moving” or “deleting” an operation source is an “operation of erasing a target from a location where the target is originally present on a screen”. The operation processing module 120 displays a display image which inherently disappears from a screen through such an operation, in another form. On the other hand, an operation of “copying” an operation source is an “operation of leaving a target at a location where the target is originally present on a screen”. However, even in a case where of the copying operation, the operation processing module 120 displays a display image at the location where the target is originally present in another form.

A display image is temporarily deformed after an operation is determined, but a display image during an operation may be temporarily deformed.

In a case where an operation performed by the user is a movement operation or a copying operation, the operation processing module 120 may deform a display image indicating a target of a movement destination or a display image indicating a target of a copying target.

The “temporary deformation” may be performed in a predefined period after an operation is determined, or in a period until the next operation is received after an operation is performed (after an operation is determined). A temporary deformation end timing is specified.

The “next operation” may include the following examples.

1. Explicit Operation for Checking Previous Operation

Specifically, this corresponds to an explicit instruction (a specific operation using a shortcut key, or an instruction from a menu opened through right-clicking) for finishing deformed display.

2. Implicit Operation for Checking Previous Operation

Specifically, after a movement operation or the like is determined, deformed display is started, and the deformed display is finished when an operation (movement, copying, or deletion) is performed on a display image of another target.

After a movement operation or the like is determined, deformed display may be started when an operation is performed on a display image of another target.

The operation processing module 120 may deform a display image indicating a target before being operated and a display image indicating a target after being operated. In other words, both of a display image before being operated and a display image after being operated may be deformed. Specifically, in a case where an operation is an operation of moving, copying, or deleting a target from a location where the target is originally present on a screen, the operation processing module 120 may deform a display image indicating the target in a state in which the target before being operated remains on the screen, and, in a case of a movement or copying operation, the operation processing module 120 may deform a display image indicating a target of a movement destination or a display image indicating a target of a copying destination. Consequently, an operator easily specifies a correspondence relationship.

In a case where a target before being operated is included in another target, the operation processing module 120 may temporarily deform display images indicating other targets. “Other targets” here include a folder or the like. Specifically, in a case where an object in a folder is moved or copied to another object (including a desktop), the folder of a movement source or a copying source is deformed.

Modification examples of other targets (a folder or the like) may include the following examples.

In a case where an operation source or an operation destination is not present in the currently displayed layer, a layer in which the operation source or the operation destination is present may be displayed. Specifically, this corresponds to opening a folder.

When an operation instruction from the user is received, a folder may be opened.

In a case where a target after being operated is included in another target, the operation processing module 120 may temporarily deform display images indicating other targets.

Specifically, in a case where an object is moved or copied into a folder, the folder of a movement destination or a copying destination may be deformed.

Modification examples of other targets (a folder or the like) may include the following examples.

In a case where an operation source or an operation destination is not present in the currently displayed layer, a layer in which the operation source or the operation destination is present may be displayed. Specifically, this corresponds to opening a folder.

When an operation instruction from the user is received, a folder may be opened.

In a case where a first operation is performed on a target by the user, and then a predefined second operation is detected, the operation processing module 120 may temporarily deform a display image indicating the target in the first operation in response to the first operation. In other words, a temporary deformation start timing is specified, and detection of the second operation is a timing of starting deformation.

Here, the “case where the first operation is performed, and then the predefined second operation is detected” is a case where other operations are not performed between the first operation and the second operation. Specifically, in a case where the first operation and the second operation are consecutively performed, the second operation is performed immediately after the first operation is performed. Therefore, a temporal gap may be present between the first operation and the second operation.

Of course, an end timing in this case is equivalent to the above-described term “temporary”.

The operation processing module 120 may deform a display image into a display image corresponding to the type of operation on the basis of the type of operation. For example, in a case where the type of operation is a “deletion” operation, an icon of a trash box may be added to a display image. In a case where the type of operation is a “movement” operation, an icon of an arrow manufactured added to a display image.

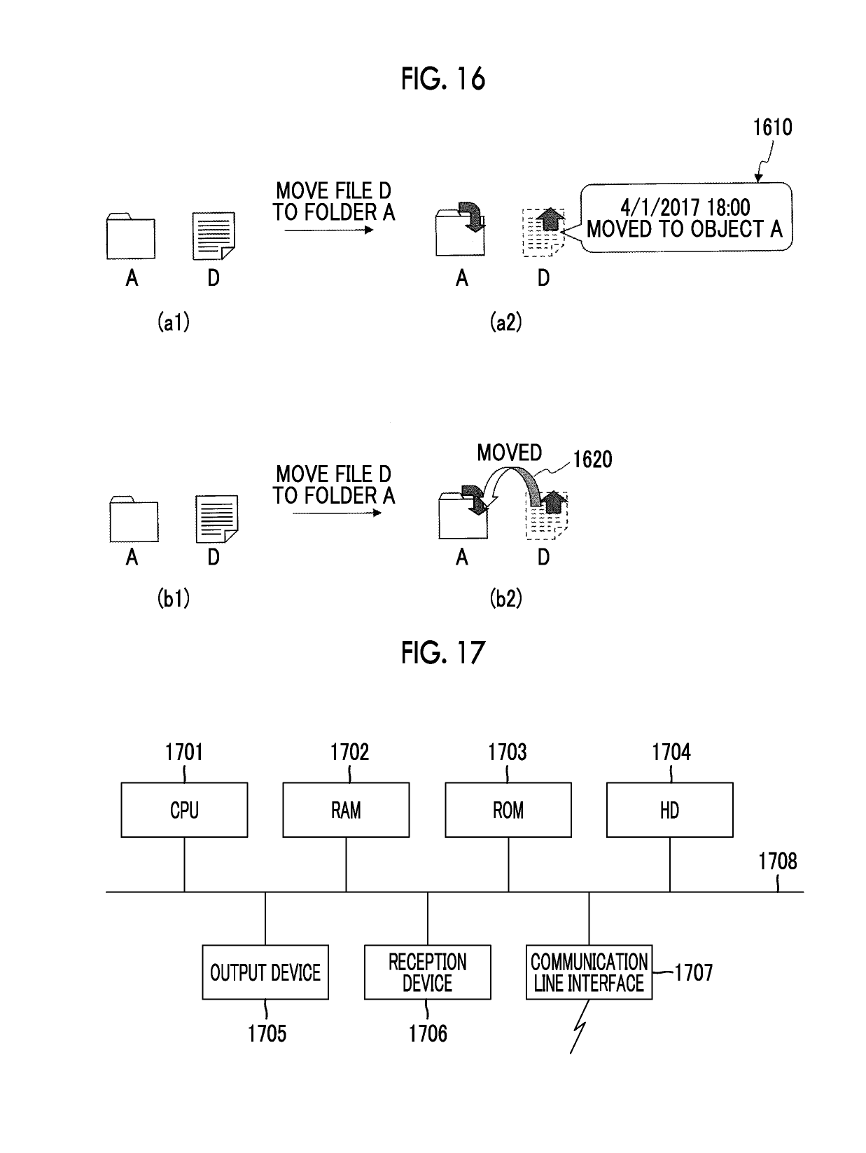

In a case where the type of operation is a movement operation, the operation processing module 120 may add an image for correlating a display image of a movement source with a display image of a movement destination. For example, in a case where the above-described icon of an arrow is used in a “movement” operation, a movement source may be correlated with a movement destination with an arrow. Specifically, this will be described later by using examples in (b1) and (b2) of FIG. 16.

Regarding a presentation process in the operation presentation module 125, the operation location presentation module 130, and the operation result presentation module 135, a process result, an operation result, or the like in the operation processing module 120 is presented to the user by using a display device (the above-described liquid crystal display, a liquid crystal display also used as a touch panel, or the like). A process result or the like may be presented to the user, for example, by combining voice output from a speaker, a tactile sense using a tactile device, and the like with each other.

The operation presentation module 125 is connected to the operation processing module 120. The operation presentation module 125 changes display forms of a display image of an operation source and a display image of an operation destination, and temporarily presents an operation target and an operation type, under the control of the operation processing module 120. The user can check the previous operation, or an operation target and an operation type in the last operation on a specific target through a change of a display image.

The operation location presentation module 130 is connected to the operation processing module 120. The operation location presentation module 130 opens an operation source and an operation destination, and presents an operation location, under the control of the operation processing module 120. The user can open and check an operation destination and an operation source (for example, a folder or the like) in a specific operation.

The operation result presentation module 135 is connected to the operation processing module 120. The operation result presentation module 135 presents a result of an operation on a target. Consequently, for example, the user can check the last operation on the target. In other words, under the control of the operation processing module 120, the operation result presentation module 135 presents an operation performed on a target in a case where a predefined third operation performed on a display image indicating the target is detected.

The presented “operation performed on the target” may be an operation performed on the target last, and may be a list of operations performed on the target. The number of operations presented in the former case is one, and the number of operations presented in the latter case is one or more (generally, plural).

The operation result presentation module 135 may present a content of another target included in a target before being operated.

In a case where there is the user's operation of presenting a content of another target, the content of another target may be presented.

“Presenting the content of another target” corresponds to opening a folder, for example, in a case where “another target” is the folder.

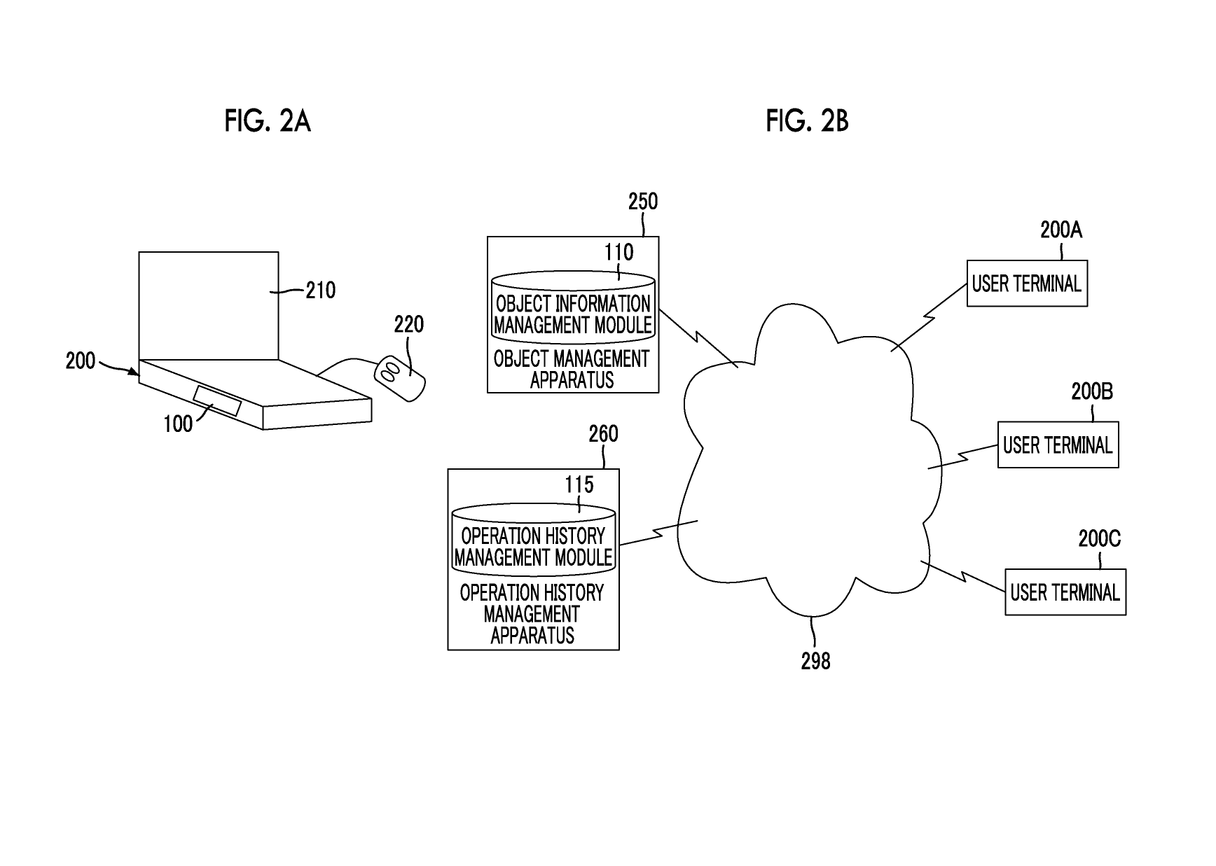

FIGS. 2A and 2B are diagrams illustrating a system configuration example according to the present exemplary embodiment.

FIG. 2A illustrates an example of a user terminal 200 such as a notebook PC. The user terminal 200 includes the information processing apparatus 100 and a display device 210, and is connected to a mouse 220. For example, the user operates the mouse 220, and thus operates an icon of an object displayed on the display device 210. In this case, the information processing apparatus 100 temporarily deforms an icon of an operation source and an icon of an operation destination such that an operation performed just before can be checked.

FIG. 2B illustrates an example of a case where the object information management module 110 and the operation history management module 115 of the information processing apparatus 100 are provided outside. An object management apparatus 250 includes the object information management module 110. An operation history management apparatus 260 includes the operation history management module 115. A user terminal 200A, a user terminal 200B, a user terminal 200C, the object management apparatus 250, and the operation history management apparatus 260 are connected to each other via a communication line 298. The communication line 298 may be a wireless line, a wired line, or a combination thereof, and may be, for example, the Internet or an intranet as a communication infrastructure. The functions of the object management apparatus 250 and the operation history management apparatus 260 may be realized by a cloud service.

In a case where the information processing apparatus 100 of the user terminal 200 accesses the object information management module 110 and the operation history management module 115, the information processing apparatus 100 accesses the object management apparatus 250 and the operation history management apparatus 260 via the communication line 298.

FIG. 3 is a diagram illustrating data structure examples of the operation history management table 300 and the object information management table 350. The operation history management table 300 is stored in the operation history management module 115, and the object information management table 350 is stored in the object information management module 110.

(a) of FIG. 3 is a diagram illustrating a data structure example of the operation history management table 300. An operation on an object is stored in the operation history management table 300.

The operation history management table 300 has an operation ID field 302, an operation date and time field 304, an operation type field 306, an operation object ID field 308, an operation destination object ID field 310, and an operation source object ID field 312. In the present exemplary embodiment, the operation ID field 302 stores information (operation identification: ID) for uniquely identifying an operation. The operation date and time field 304 stores the date and time (which may be year, month, day, hour, minute, second, second or less, or a combination thereof) at which the operation is performed. The operation type field 306 stores the type of operation (for example, movement, copying, and deletion operations). In the present exemplary embodiment, the operation object ID field 308 stores information (operation object ID) for uniquely identifying an object which is an operation target. The operation destination object ID field 310 stores an object ID which is an operation destination in the operation. The operation source object ID field 312 stores an object ID which is an operation source in the operation.

(b) of FIG. 3 is a diagram illustrating a data structure example of the object information management table 350. The object information management table 350 stores information regarding an object (principally, a configuration between objects).

The object information management table 350 has an object ID field 352, an object name field 354, and a parent object ID field 356. The object ID field 352 stores an object ID. The object name field 354 stores an object name of the object ID. The parent object ID field 356 stores a parent object ID (generally, an object ID of a folder or the like in which the object is stored) of the object.

An operation content (process content) on an object is determined by using the operation history management table 300 and the object information management table 350. In other words, configurations of an object of an operation destination and an object of an operation source are referred to from the object information management table 350 on the basis of an object ID in the operation history management table 300. For example, it is illustrated that, in the second row (operation ID of 2) of the operation history management table 300 in (a) of FIG. 3, a file E (a row 384; and an object ID of 6) is moved from a desktop (object ID of 1) to a folder B (a row 382; and object ID of 3) in the object information management table 350 in (b) of FIG. 3.

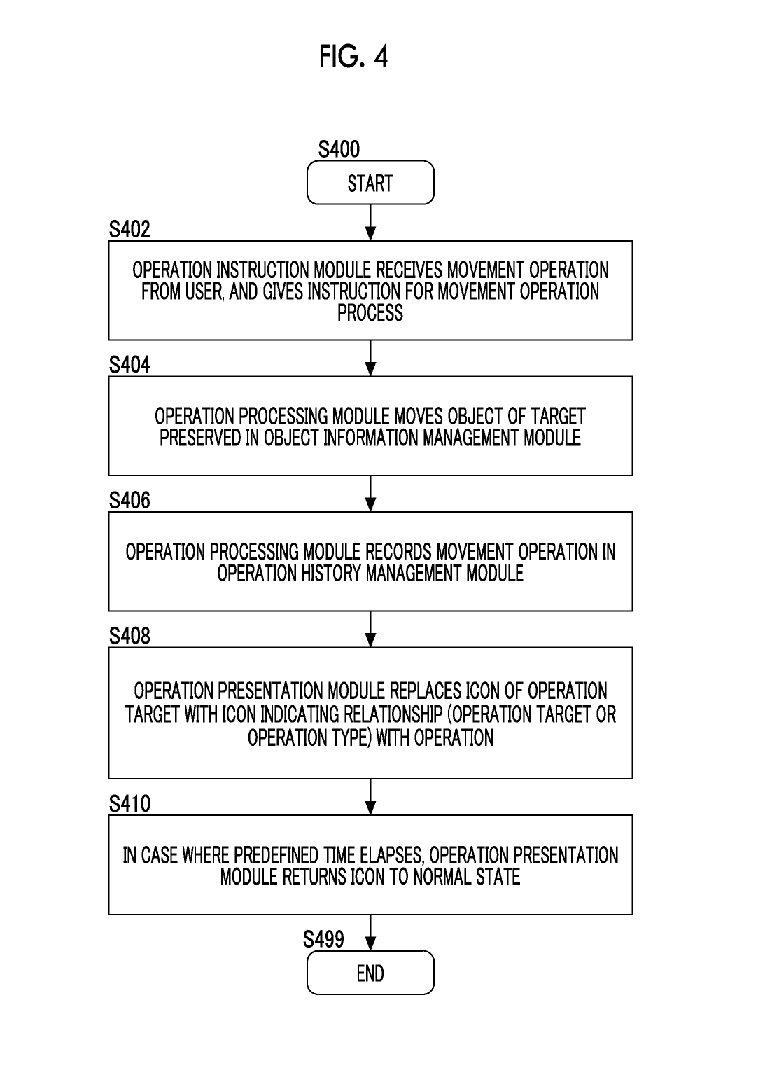

FIG. 4 is a flowchart illustrating a process example according to the present exemplary embodiment. FIG. 4 illustrates a process example in a case where an object is moved.

In step S402, the operation instruction module 105 receives a movement operation from the user, and gives an instruction for a movement operation process.

In step S404, the operation processing module 120 moves an object of a target preserved in the object information management module 110.

In step S406, the operation processing module 120 records the movement operation in the operation history management module 115.

In step S408, the operation presentation module 125 replaces an icon of the operation target with an icon indicating a relationship (an operation target or an operation type) with the operation.

In step S410, in a case where a predefined time elapses, the operation presentation module 125 returns the icon to a normal state.

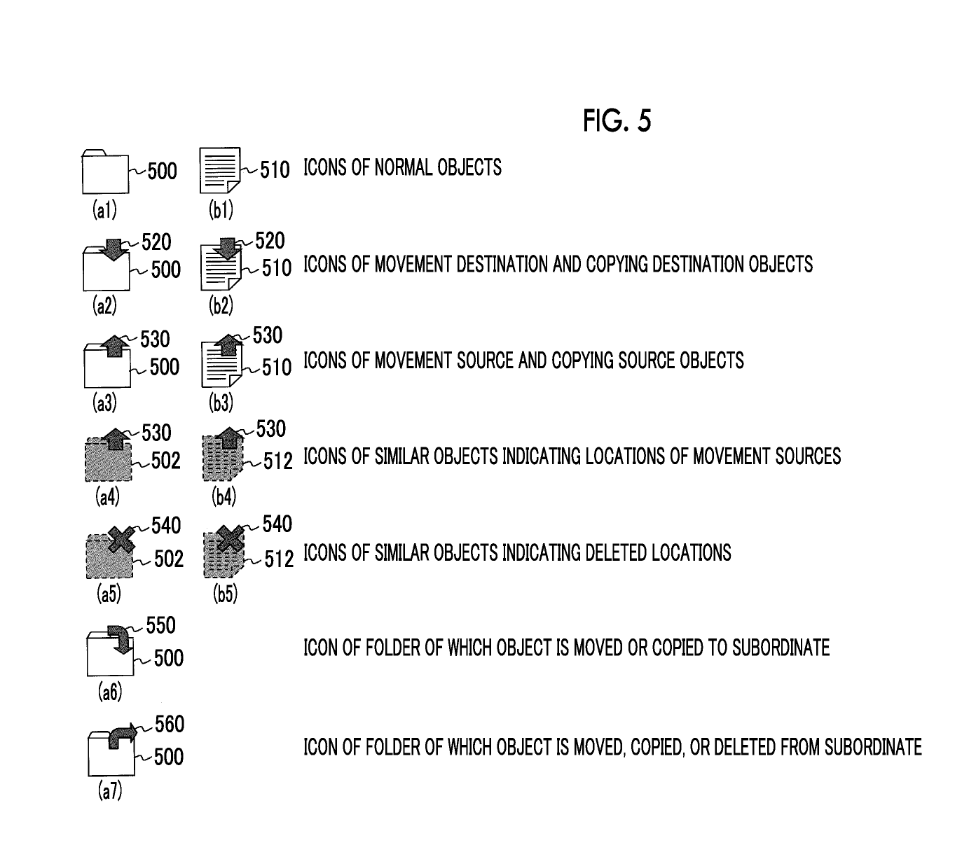

FIG. 5 is a diagram illustrating a process example according to the present exemplary embodiment. FIG. 5 illustrates deformation process examples. (a) side of FIG. 5 illustrates an example in which an object is a folder. (b) side of FIG. 5 illustrates an example in which an object is a file (document).

A folder icon 500 and a file icon 510 illustrated in the examples in (a1) and (b1) of FIG. 5 are icons of objects in a normal state. In other words, a state before deformation (or after temporary deformation) is illustrated.

The examples in (a2) and (b2) of FIG. 5 correspond to examples icons of movement destination and copying destination objects.

The deformed icon illustrated in the example in (a2) of FIG. 5 is obtained by adding a movement destination/copying destination mark 520 to the folder icon 500.

The deformed icon illustrated in the example in (b2) of FIG. 5 is obtained by adding the movement destination/copying destination mark 520 to the file icon 510.

The examples in (a3) and (b3) of FIG. 5 correspond to examples icons of movement source and copying source objects.

The deformed icon illustrated in the example in (a3) of FIG. 5 is obtained by adding a movement source/copying source mark 530 to the folder icon 500.

The deformed icon illustrated in the example in (b3) of FIG. 5 is obtained by adding the movement source/copying source mark 530 to the file icon 510.

The examples in (a4) and (b4) of FIG. 5 correspond to examples of icons of similar objects indicating locations of movement sources.

The deformed icon illustrated in the example in (a4) of FIG. 5 is obtained by adding the movement source/copying source mark 530 to a similar folder icon 502.

The deformed icon illustrated in the example in (b4) of FIG. 5 is obtained by adding the movement source/copying source mark 530 to a similar file icon 512.

The examples in (a5) and (b5) of FIG. 5 correspond to examples of icons of similar objects indicating deleted locations.

The deformed icon illustrated in the example in (a5) of FIG. 5 is obtained by adding a deletion mark 540 to the similar folder icon 502.

The deformed icon illustrated in the example in (b5) of FIG. 5 is obtained by adding the deletion mark 540 to the similar file icon 512.

The example in (a6) of FIG. 5 corresponds to an icon of a folder of which an object is moved or copied to a subordinate.

The deformed icon illustrated in the example in (a6) of FIG. 5 is obtained by adding a subordinate movement destination/copying destination mark 550 to the folder icon 500.

The example in (a7) of FIG. 5 corresponds to an icon of a folder of which an object is moved, copied, or deleted from a subordinate.

The deformed icon illustrated in the example in (a7) of FIG. 5 is obtained by adding a subordinate movement source/copying source mark 560 to the folder icon 500.

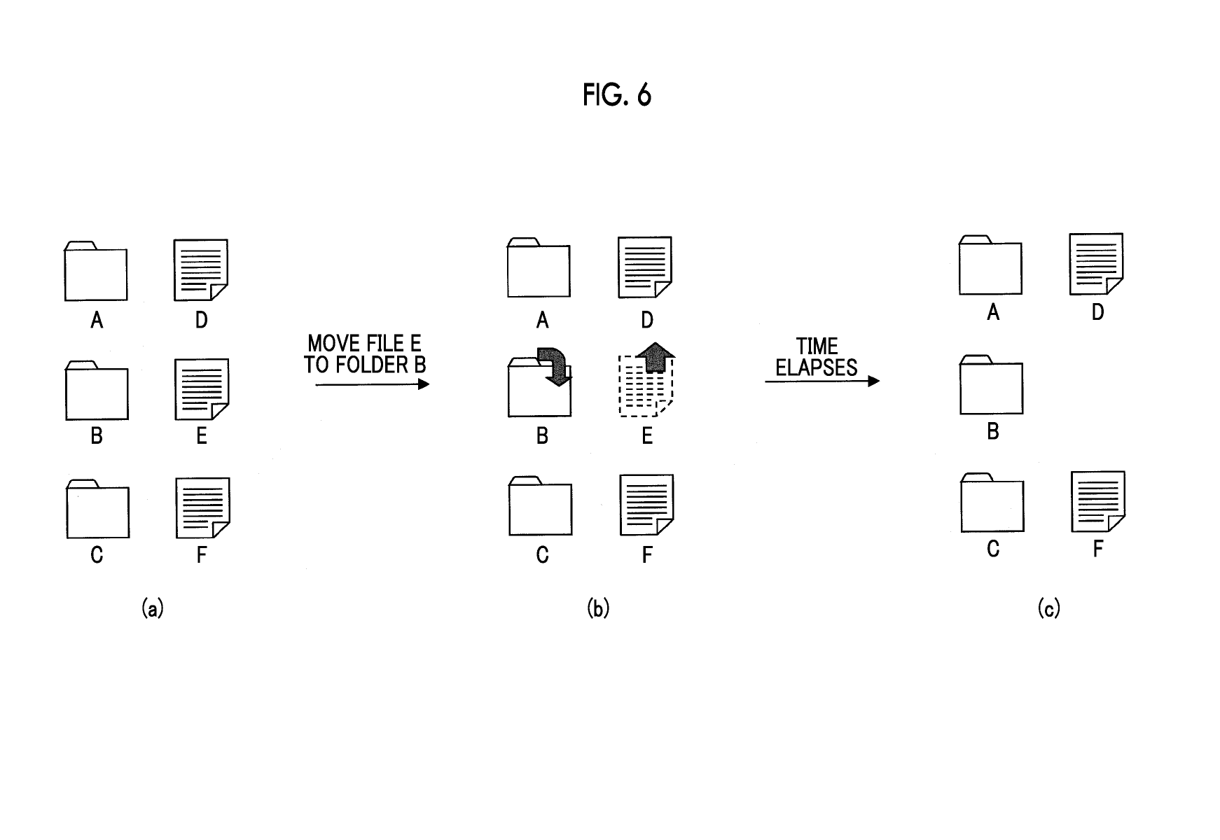

FIG. 6 is a diagram illustrating a process example according to the present exemplary embodiment. FIG. 6 illustrates an object movement process example according to the flowchart of FIG. 4.

In an example in (a) of FIG. 6, there are folders (icons A, B, and C) and files (icons D, E, and F) on a desktop.

Here, it is assumed that the user performs an operation of moving the file E to the folder B.

In a case where this operation is performed, as illustrated in the example in (b) of FIG. 6, the icon E (movement source) of the file is deformed into the deformed icon illustrated in the example in (b4) of FIG. 5. The icon B (movement destination) of the folder is deformed into the deformed icon illustrated in the example in (a6) of FIG. 5. The operation target icons (the file E and the folder B) are temporarily deformed (in this case, for a predefined time).

The example in (c) of FIG. 6 illustrates a state after the time elapses. In other words, the deformation of the icons (the file E and the folder B) disappears, and thus the original icon state after the movement process is obtained.

Specifically, the file E is erased (erased in terms of display) from the desktop, and the folder B has the same state as the state before the operation.

During display of the example in (b) of FIG. 6, the user can check that the user has performed the operation of moving the file E to the folder B.

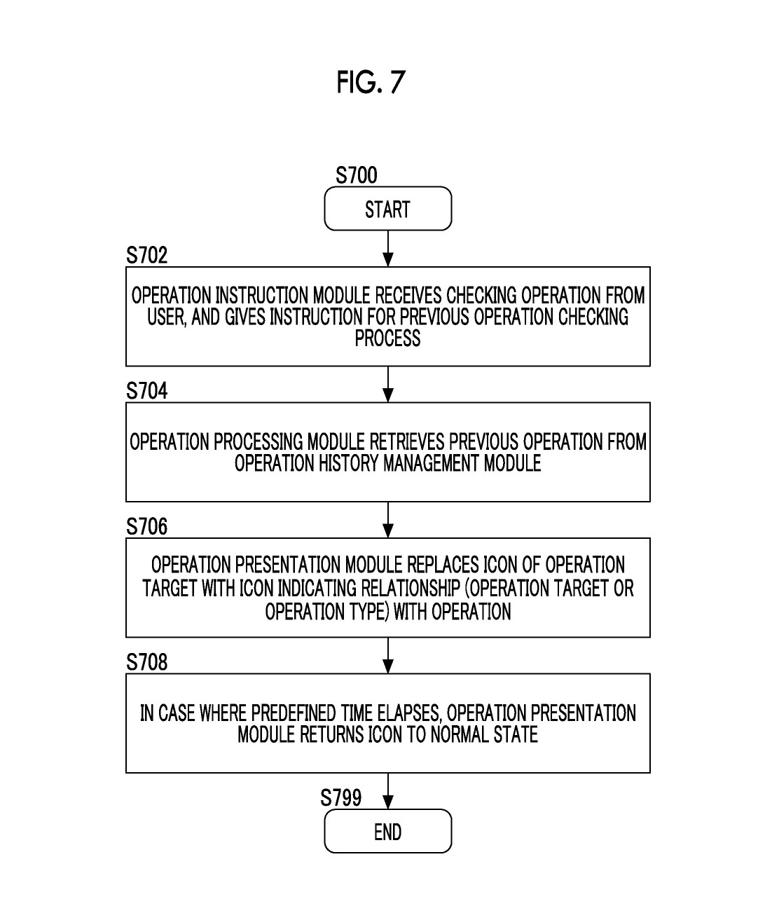

FIG. 7 is a flowchart illustrating a process example according to the present exemplary embodiment. FIG. 7 illustrates a process example for checking the previous operation.

In step S702, the operation instruction module 105 receives a checking operation from the user, and gives an instruction for a previous operation checking process.

In step S704, the operation processing module 120 retrieves the previous operation from the operation history management module 115.

In step S706, the operation presentation module 125 replaces an icon of the operation target with an icon indicating a relationship (an operation target or an operation type) with the operation.

In step S708, in a case where a predefined time elapses, the operation presentation module 125 returns the icon to a normal state.

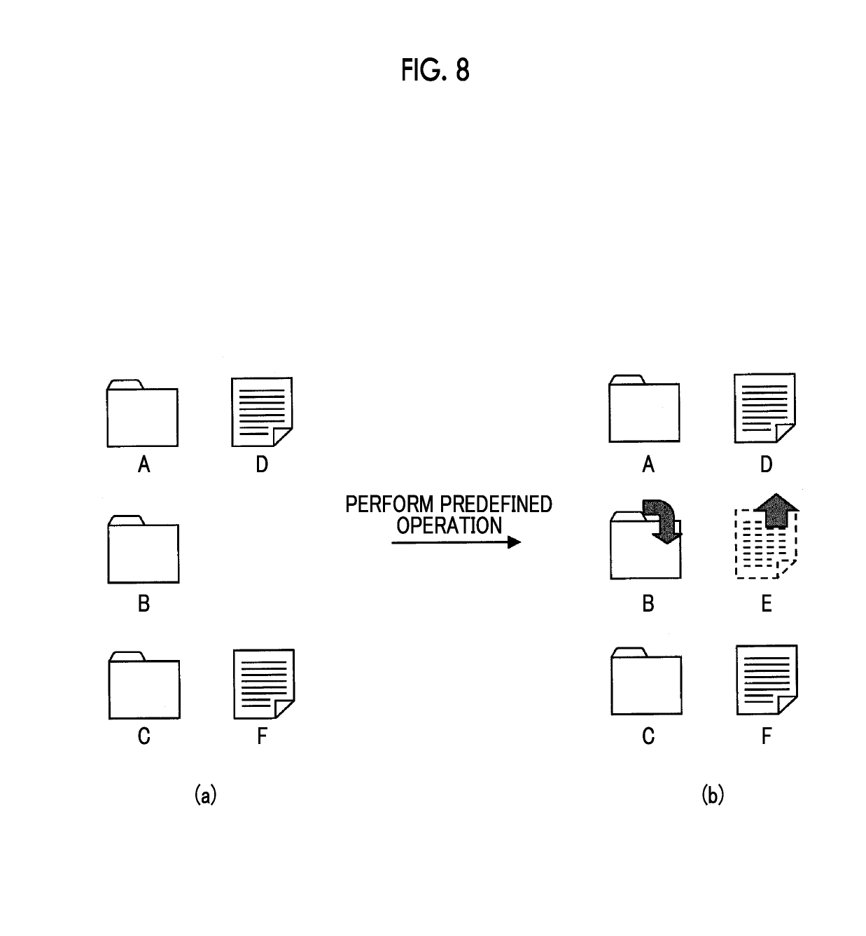

FIG. 8 is a diagram illustrating a process example according to the present exemplary embodiment. FIG. 8 illustrates a process example for checking the previous operation (the movement operation illustrated in the example in FIG. 6) according to the flowchart of FIG. 7.

A state illustrated in the example in (a) of FIG. 8 is the same as the state illustrated in the example in (c) of FIG. 6.

In this state, in a case where the user performs a predefined operation, the icon of the previous operation target is deformed, and the display as illustrated in the example in (b) of FIG. 6 is performed. In other words, the icon B of the folder is deformed into the deformed icon illustrated in the example in (a6) of FIG. 5, the icon (the deformed icon illustrated in the example in (b4) of FIG. 5) into which the icon E of the file is deformed is displayed at the location where the icon is originally present.

The “predefined operation” may be, for example, to use a shortcut key (for example, Ctr1+O), or to select a “previous operation check” item from a menu opened through right-clicking at a location where there is no icon.

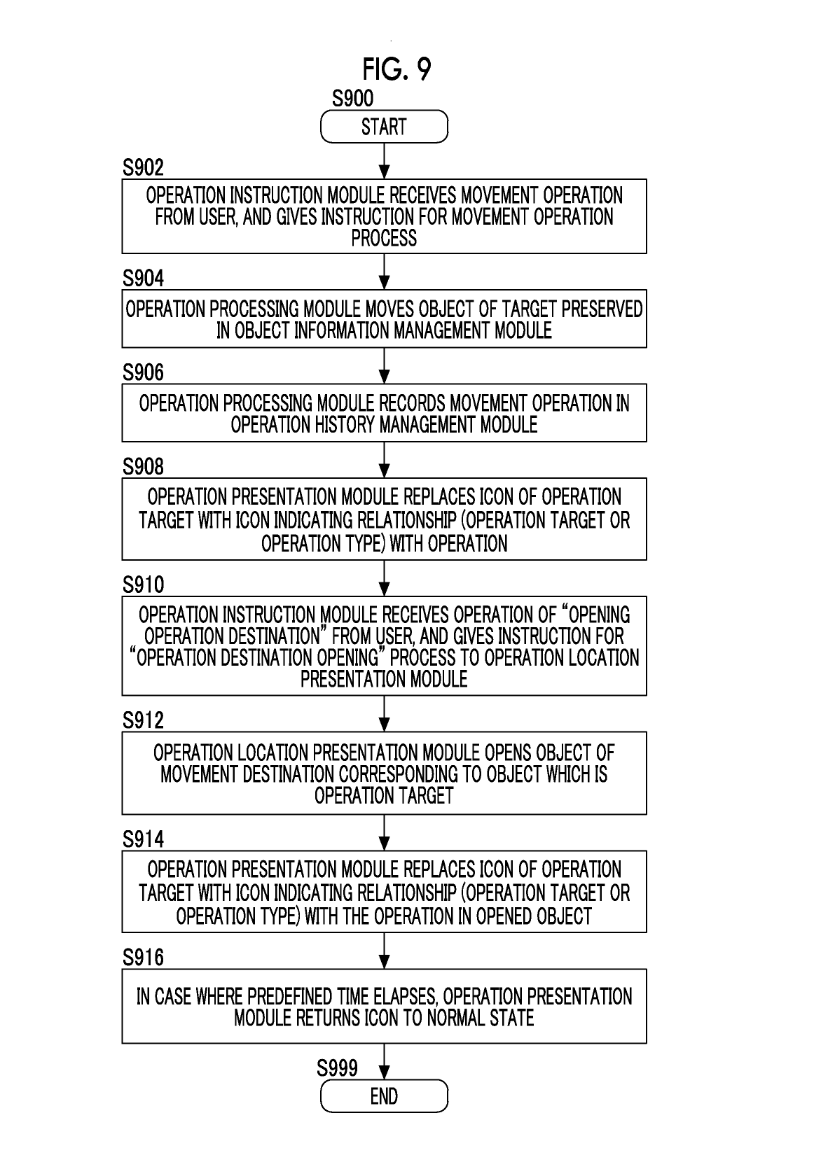

FIG. 9 is a flowchart illustrating a process example according to the present exemplary embodiment. The process example corresponds to a process in which step S910 to step S914 are inserted between step S408 and step S410 in the flowchart illustrated in the example in FIG. 4.

In step S902, the operation instruction module 105 receives a movement operation from the user, and gives an instruction for a movement operation process.

In step S904, the operation processing module 120 moves an object of a target preserved in the object information management module 110.

In step S906, the operation processing module 120 records the movement operation in the operation history management module 115.

In step S908, the operation presentation module 125 replaces an icon of the operation target with an icon indicating a relationship (an operation target or an operation type) with the operation.

In step S910, the operation instruction module 105 receives an operation of “opening an operation destination” from the user, and gives an instruction for an “operation destination opening” process to the operation location presentation module 130.

In step S912, the operation location presentation module 130 opens an object of a movement destination corresponding to an object which is an operation target.

In step S914, the operation presentation module 125 replaces an icon of the operation target with an icon indicating a relationship (an operation target or an operation type) with the operation in the opened object.

In step S916, in a case where a predefined time elapses, the operation presentation module 125 returns the icon to a normal state.

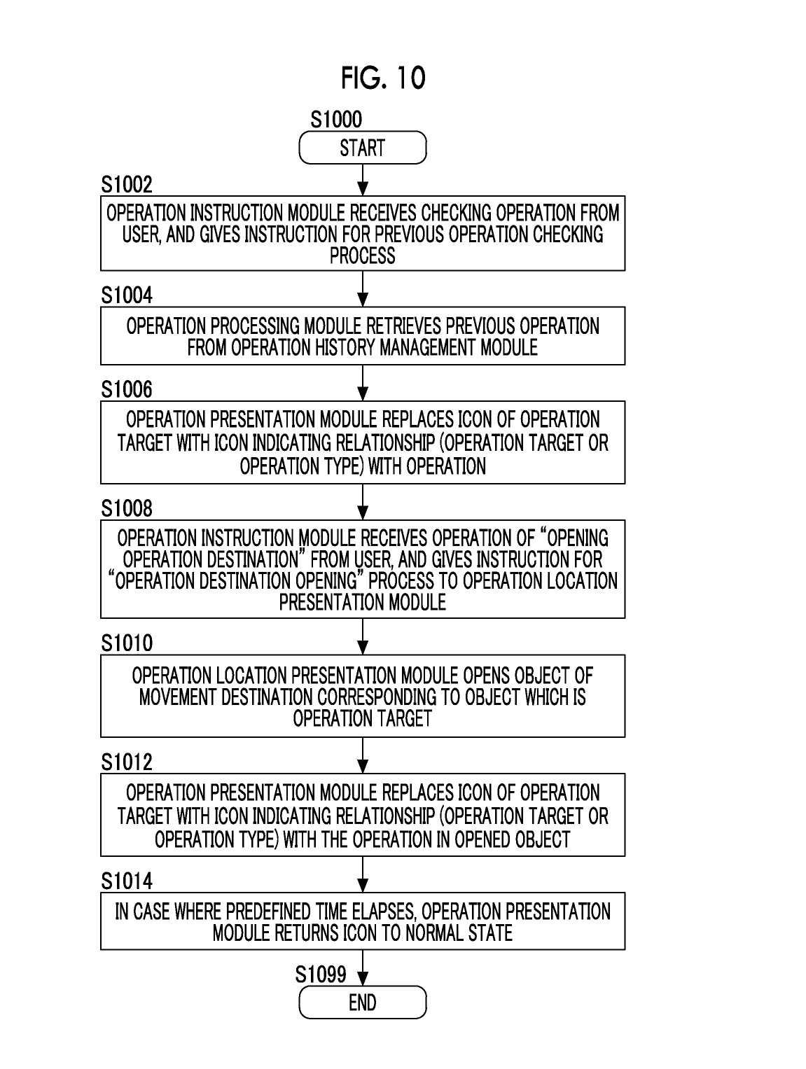

FIG. 10 is a flowchart illustrating a process example according to the present exemplary embodiment. The process example corresponds to a process in which step S1008 to step S1012 are inserted between step S706 and step S708 in the flowchart illustrated in the example in FIG. 7.

In step S1002, the operation instruction module 105 receives a checking operation from the user, and gives an instruction for a previous operation checking process.

In step S1004, the operation processing module 120 retrieves the previous operation from the operation history management module 115.

In step S1006, the operation presentation module 125 replaces an icon of the operation target with an icon indicating a relationship (an operation target or an operation type) with the operation.

In step S1008, the operation instruction module 105 receives an operation of “opening an operation destination” from the user, and gives an instruction for an “operation destination opening” process to the operation location presentation module 130.

In step S1010, the operation location presentation module 130 opens an object of a movement destination corresponding to an object which is an operation target.

In step S1012, the operation presentation module 125 replaces an icon of the operation target with an icon indicating a relationship (an operation target or an operation type) with the operation in the opened object.

In step S1014, in a case where a predefined time elapses, the operation presentation module 125 returns the icon to a normal state.

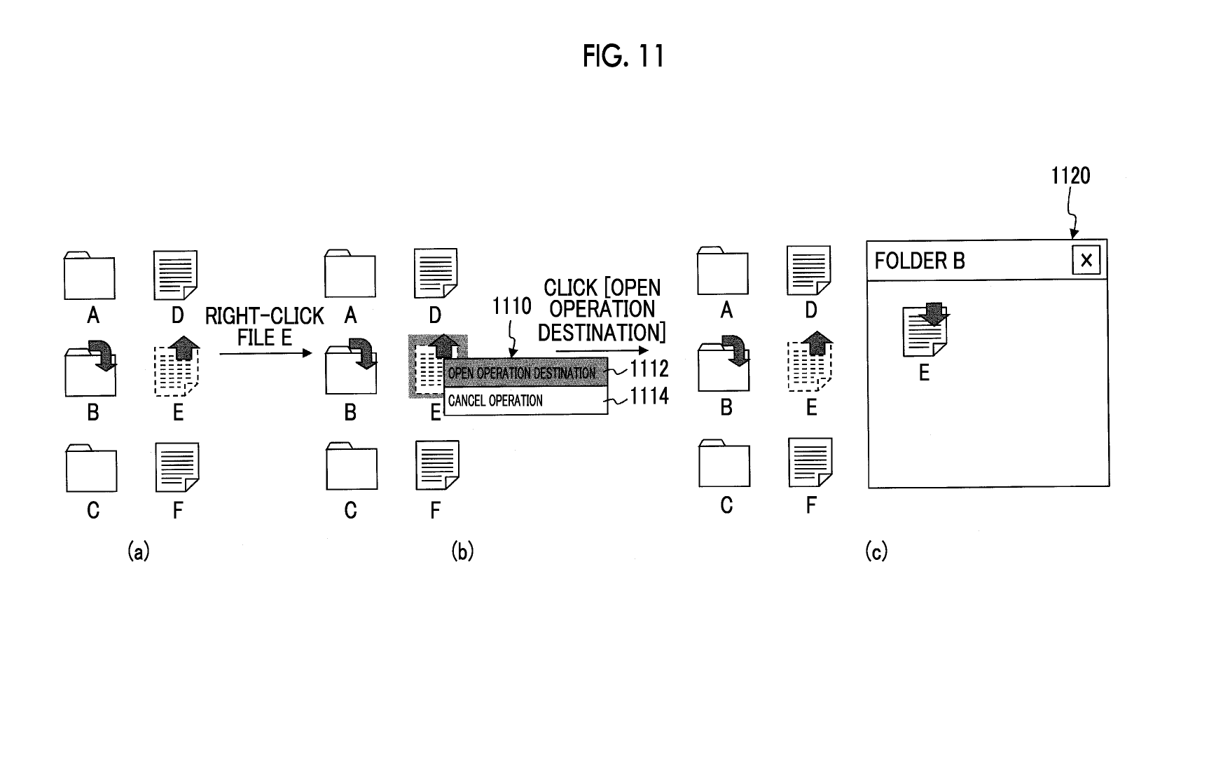

FIG. 11 is a diagram illustrating a process example according to the present exemplary embodiment. FIG. 11 illustrates a process example (step S910 to step S914, and step S1008 to step S1012) in a case where an operation of “opening an operation destination” is received according to the flowcharts illustrated in FIGS. 9 and 10.

A state illustrated in the example in (a) of FIG. 11 is the same as the illustrated in the example in (b) of FIG. 6 or (b) of FIG. 8. In other words, the state is a state in which a deformed icon is displayed.

In a case where the user performs right-clicking on the file E in this state, a menu 1110 is displayed as illustrated in the example in (b) of FIG. 11. The menu 1110 includes, for example, an “open operation destination” menu 1112 and a “cancel operation” menu 1114. Here, it is assumed that the “open operation destination” menu 1112 is clicked.

As illustrated in the example in (c) of FIG. 11, the folder B which is a movement destination of the file E is opened as in a folder B subordinate display region 1120. An icon (the deformed icon illustrated in the example in (b2) of FIG. 5) indicating that the file E has been moved is displayed in the folder B subordinate display region 1120.

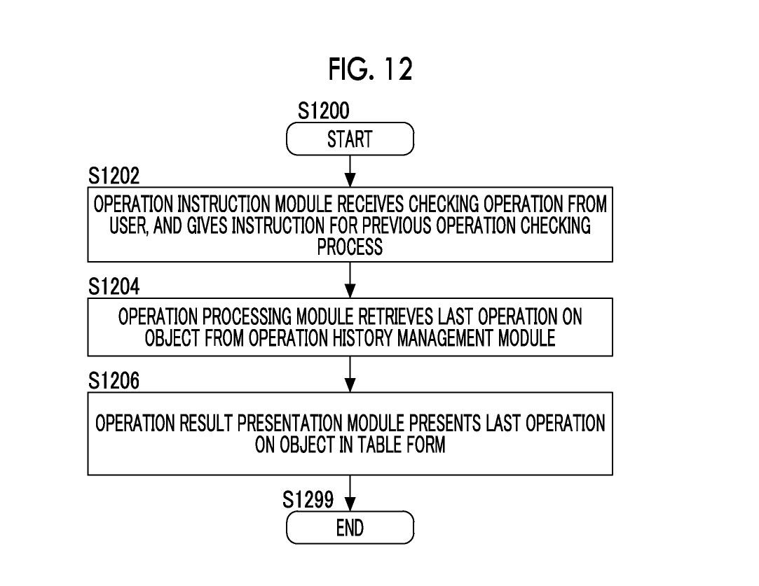

FIG. 12 is a flowchart illustrating a process example according to the present exemplary embodiment. FIG. 12 illustrates a process example of checking the last operation (latest operation) on an object. A target object here is an object selected through the user's operation.

In step S1202, the operation instruction module 105 receives a checking operation from the user, and gives an instruction for an object operation checking process.

In step S1204, the operation processing module 120 retrieves the last operation on the object from the operation history management module 115.

In step S1206, the operation result presentation module 135 presents the last operation on the object in a table form.

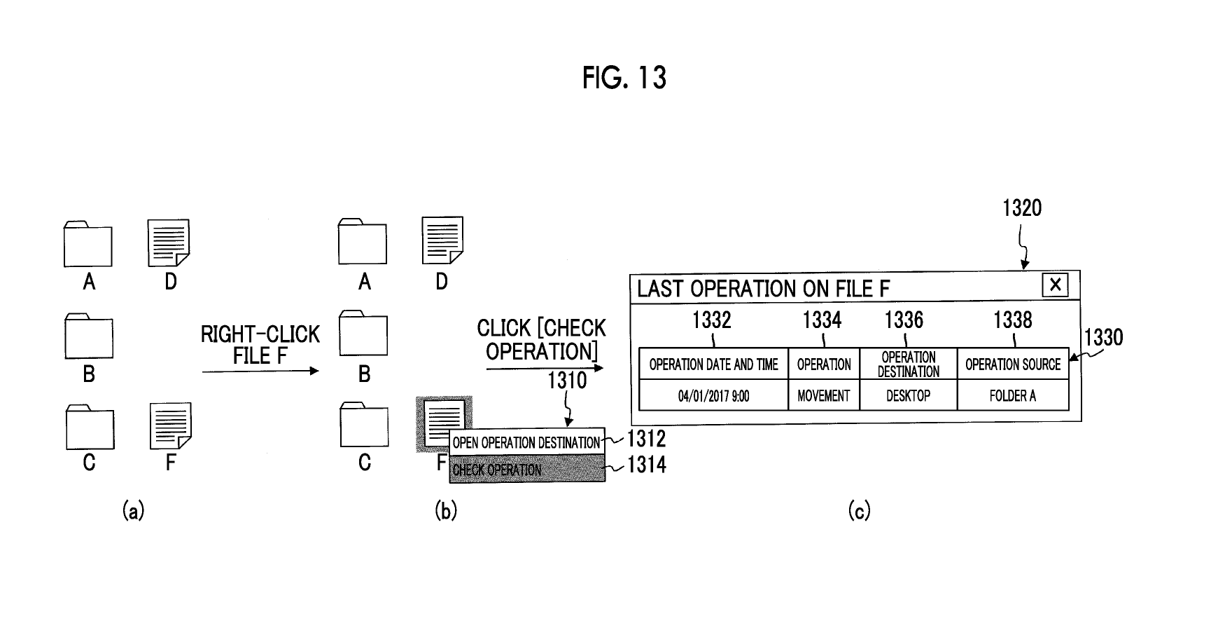

FIG. 13 is a diagram illustrating a process example according to the present exemplary embodiment. FIG. 13 illustrates a process example of checking the last operation (latest operation) on an object according to the flowchart of FIG. 12.

The example in (a) of FIG. 13 is the same as the example in (c) of FIG. 6. In other words, a certain operation is performed, and, in a case where the user performs right-clicking on the file F in this state, an operation menu for the file F is displayed. Specifically, as illustrated in the example in (b) of FIG. 13, a menu 1310 is displayed. The menu 1310 includes, for example, an “open operation destination” menu 1312 and a “check operation” menu 1314. Here, it is assumed that the “check operation” menu 1314 is clicked.

As illustrated in the example in (c) of FIG. 13, a history of the last operation on the file F is displayed in a table form. Specifically, an operation information table 1330 is displayed in a past operation display region 1320. The operation information table 1330 has an operation date and time field 1332, an operation field 1334, an operation destination field 1336, and an operation source field 1338. The operation date and time field 1332 displays the date and time at which an operation is performed. The operation field 1334 displays the type of the operation. The operation destination field 1336 displays an operation destination in the operation. The operation source field 1338 displays an operation source in the operation.

Here, the past operation display region 1320 may be displayed, and the icons of the file F and the folder A may be further deformed. Specifically, the file F may be deformed into the icon illustrated in the example in (b2) of FIG. 5, and the folder A may be deformed into the icon illustrated in the example in (a3) of FIG. 5.

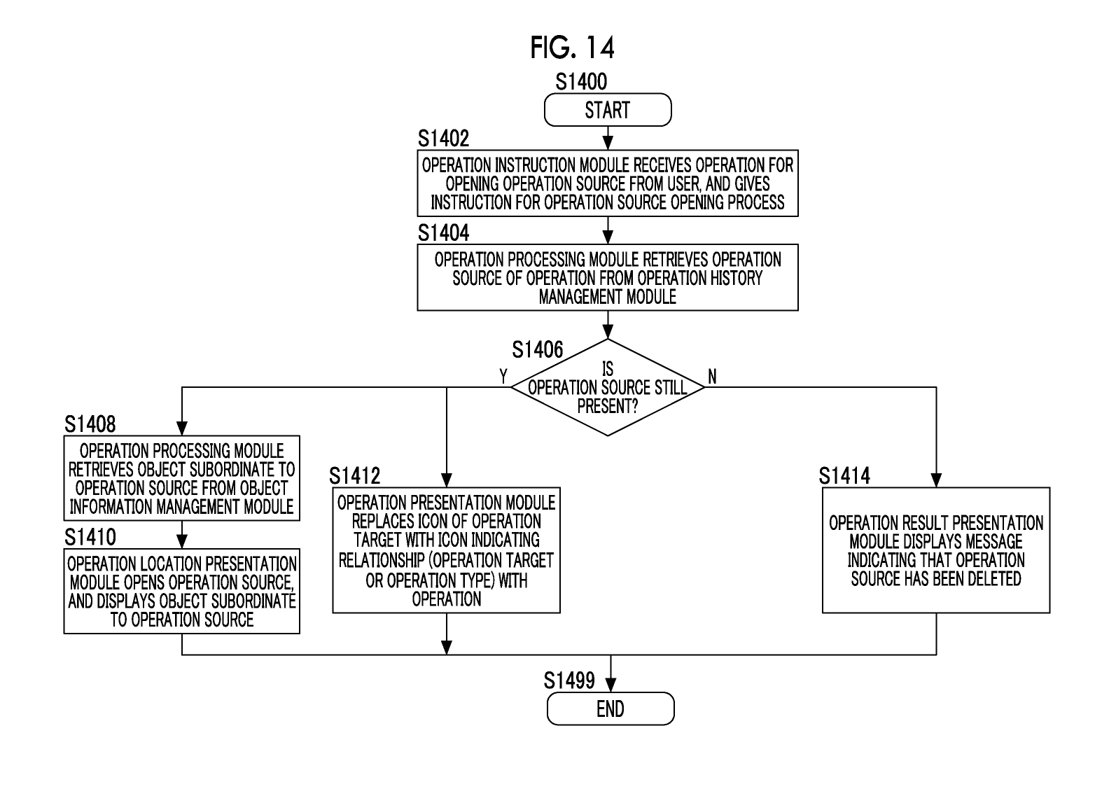

FIG. 14 is a flowchart illustrating a process example according to the present exemplary embodiment. FIG. 14 illustrates a process example of opening an operation source from a past operation display screen.

In step S1402, the operation instruction module 105 receives an operation for opening an operation source from the user, and gives an instruction for an operation source opening process.

In step S1404, the operation processing module 120 retrieves an operation source of the operation from the operation history management module 115.

In step S1406, it is determined whether or not the operation source is still present, and, in a case where the operation source is still present, the flow proceeds to step S1408 and step S1412, and, in other cases, the flow proceeds to step S1414.

In step S1408, the operation processing module 120 retrieves an object subordinate to the operation source from the object information management module 110.

In step S1410, the operation location presentation module 130 opens the operation source, and displays the object subordinate to the operation source.

In step S1412, the operation presentation module 125 replaces an icon of the operation target with an icon indicating a relationship (an operation target or an operation type) with the operation.

In step S1414, the operation result presentation module 135 displays a message indicating that the operation source has been deleted.

Any one of the processes in step S1408, step S1410, and step S1412 may be performed first, and the processes may be performed in parallel to each other.

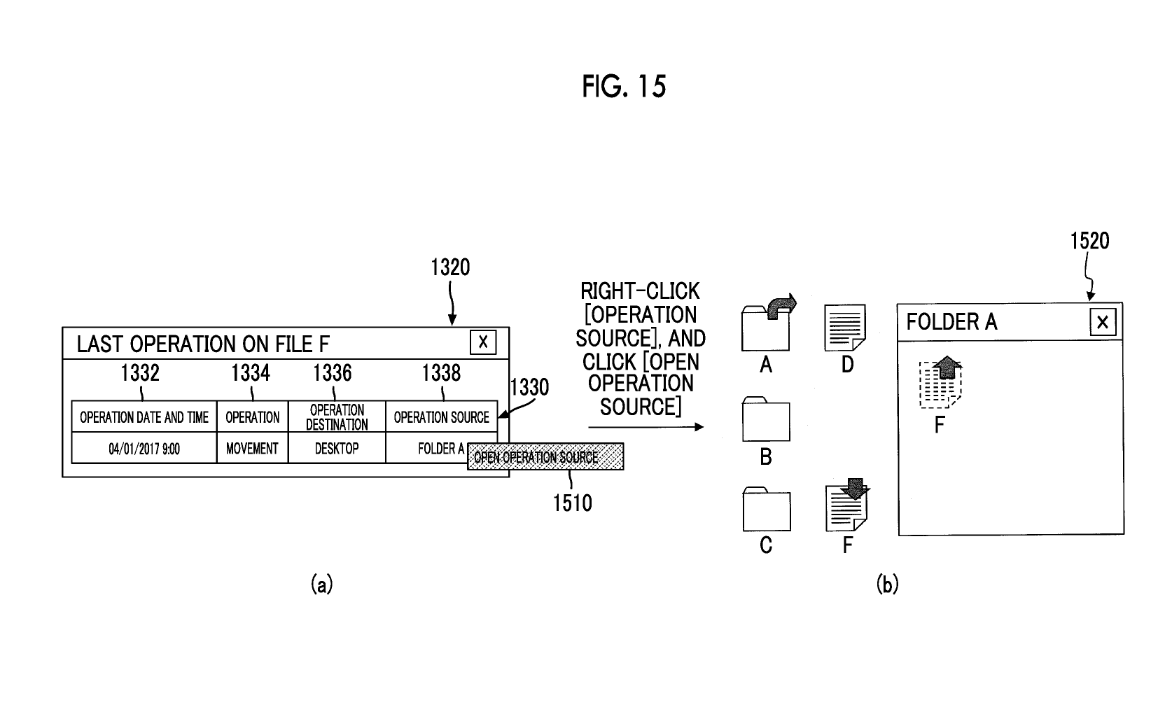

FIG. 15 is a diagram illustrating a process example according to the present exemplary embodiment. FIG. 15 illustrates a process example of opening an operation source from the past operation display region according to the flowchart of FIG. 14.

The example in (a) of FIG. 15 corresponds to the past operation display region 1320 illustrated in the example in (c) of FIG. 13. In a case where the user performs an operation of right-clicking on the operation source field 1338 of the operation information table 1330 of the past operation display region 1320, an “open operation source” menu 1510 is displayed. Here, it is assumed that the “open operation source” menu 1510 is clicked.

The example in (b) of FIG. 15 corresponds to an example of opening an operation source. Specifically, the folder A which is a movement source of the file F is opened as in a folder A subordinate display region 1520. An icon (the deformed icon illustrated in the example in (b4) of FIG. 5) indicating the movement source of the file F is displayed in the folder A subordinate display region 1520. The file F is deformed into a deformed icon (the deformed icon illustrated in the example in (b2) of FIG. 5) indicating that the file F has been moved, and the folder A is deformed into a deformed icon (the deformed icon illustrated in the example in (a7) of FIG. 5) indicating that the file has been moved from the subordinate thereof.

FIG. 16 is a diagram illustrating a process example according to the present exemplary embodiment. FIG. 16 illustrates another example of the deformed icon illustrated in the example in FIG. 5.

(a1) of FIG. 16 illustrates a state of a normal icon. Here, it is assumed that the user performs an operation of moving the file D to the folder A.

In the example in (a2) of FIG. 16, an explanation bubble 1610 indicating the operation is displayed. A content of the operation, for example, “2017/4/1 18:00, moved to the folder A” is displayed in the explanation bubble 1610. Of course, the icon A of the folder may be deformed into the deformed icon illustrated in the example in (a6) of FIG. 5, and the icon D of the file may be deformed into the deformed icon illustrated in the example in (b4) of FIG. 5.

(b1) of FIG. 16 illustrates a state of a normal icon. Here, it is assumed that the user performs an operation of moving the file D to the folder A.

In the example in (b2) of FIG. 16, a movement arrow 1620 indicating that the file D has been moved to the folder A is displayed. Of course, the icon A of the folder may be deformed into the deformed icon illustrated in the example in (a6) of FIG. 5, and the icon D of the file may be deformed into the deformed icon illustrated in the example in (b4) of FIG. 5.

A hardware configuration of a computer executing a program as the present exemplary embodiment is a hardware configuration of a general computer as exemplified in FIG. 17, and the computer is, specifically, a personal computer or a computer serving as a server. In other words, as a specific example, a CPU 1701 is used as a processing unit (calculation unit), and a RAM 1702, a ROM 1703, and an HD 1704 are used as a storage device. For example, a hard disk or a solid state drive (SSD) may be used as the HD 1704. The computer includes the CPU 1701 executing programs such as the operation instruction module 105, the operation processing module 120, the operation presentation module 125, the operation location presentation module 130, and the operation result presentation module 135; the RAM 1702 storing the programs or data; the ROM 1703 storing a program or the like for the computer; the HD 1704 which is an auxiliary storage device (which may be a flash memory or the like) functioning as the object information management module 110 and the operation history management module 115; a reception device 1706 which receives data on the basis of a user's operation (including an action, a voice, a visual line, and the like) on a keyboard, a mouse, a touch screen, a microphone, or a camera (including a visual line detection camera or the like); an output device 1705 such as a CRT, a liquid crystal display, or a speaker; a communication line interface 1707 for connection to a communication network such as a network interface card; and a bus 1708 connecting the above-described elements to each other for exchanging data. Such a plurality of computers may be connected to each other via a network.

Among the above-described exemplary embodiments, in a case of the exemplary embodiment based on a computer program, the computer program which is software is read to a system having the present hardware configuration, and the exemplary embodiment is realized through cooperation between the software and the hardware resources.

The hardware configuration illustrated in FIG. 17 corresponds to one configuration example, and the present exemplary embodiment is not limited to the configuration illustrated in FIG. 17, and any configuration in which the modules described in the present exemplary embodiment can be executed may be used. For example, some of the modules may be configured with dedicated hardware (for example, an application specific integrated circuit (ASIC)), some of the modules may be provided in an external system, and may be connected to a communication line, and such a plurality of systems illustrated in FIG. 17 may be connected to each other via a communication line so as to operate in cooperation therebetween. Particularly, the modules may be incorporated not only into a personal computer but also into a portable information communication apparatus (including a mobile phone, a smart phone, a mobile apparatus, a wearable computer, and the like), an information appliance, a robot, a copier, a facsimile, a scanner, a printer, a multi-function peripheral (an image processing apparatus having two or more functions of a scanner, a printer, copier, and a facsimile).

The program may be stored on a recording medium so as to be provided, and the program may be provided by using a communication unit. In this case, for example, the program may be understood as the invention of a “non-transitory computer readable medium storing the program”.

The “non-transitory computer readable medium storing the program” indicates a computer readable recording medium storing the program, used to install, execute, and distribute the program.

The recording medium includes, for example, “a DVD-R, a DVD-RW, a DVD-RAM, or the like” which is a digital versatile disc (DVD) and is a standard defined in the DVD forum, and “a DVD+R, DVD+RW, or the like” which is a standard defined in the DVD+RW, a compact disc (CD) read only memory (CD-ROM), a CD recordable (CD-R), or a CD rewritable (CD-RW), a Blu-ray (registered trademark) disc, a magnetooptical disc (MO), a flexible disk (FD), a magnetic tape, a hard disk, a read only memory (ROM), an electrically erasable programmable read only memory (EEPROM) (registered trademark), a flash memory, a random access memory (RAM), and a secure digital (SD) memory card.

The whole or a part of the program may be recorded on the recording medium so as to be preserved or distributed. The program may be transmitted through communication, for example, by using a transmission medium such as a wired network used for a local area network (LAN), a metropolitan area network (MAN), a wide area network (WAN), the Internet, an intranet, or an extranet, a wireless communication network, or a combination thereof, and may be carried via a carrier wave mounted therewith.

The program may be apart or the whole of another program, or may be recorded on a recording medium along with a separate program. The program may be divided and recorded on a plurality of recording media. The program may be recorded in any restorable aspect such as compression or encryption.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a deformation unit that temporarily deforms a display image indicating a target in response to an operation in a case where a user performs the operation on the target,
wherein, in a case where the operation is an operation of moving, copying, or deleting the target from a location where the target is originally present on a screen, the deformation unit deforms the display image indicating the target before being operated in a state in which the target remains.

2. An information processing apparatus comprising:
a deformation unit that temporarily deforms a display image indicating a target in response to an operation in a case where a user performs the operation on the target,
wherein, in a case where the operation is a movement or copying operation, the deformation unit deforms a display image indicating a target of a movement destination or a display image indicating a target of a copying destination.

3. The information processing apparatus according to claim 1,
wherein the deformation unit temporarily deforms the display image in a predefined period after the operation is determined, or a period until the next operation is received after the operation is performed.

4. The information processing apparatus according to claim 2,
wherein the deformation unit temporarily deforms the display image in a predefined period after the operation is determined, or a period until the next operation is received after the operation is performed.

5. The information processing apparatus according to claim 1,
wherein the deformation unit deforms a display image indicating the target before being operated and a display image indicating the target after being operated.

6. The information processing apparatus according to claim 2,
wherein the deformation unit deforms a display image indicating the target before being operated and a display image indicating the target after being operated.

7. The information processing apparatus according to claim 1,
wherein, in a case where the target before being operated is included in another target, the deformation unit temporarily deforms a display image indicating the other target.

8. The information processing apparatus according to claim 2,
wherein, in a case where the target before being operated is included in another target, the deformation unit temporarily deforms a display image indicating another target.

9. The information processing apparatus according to claim 1,
wherein, in a case where the target after being operated is included in another target, the deformation unit temporarily deforms a display image indicating another target.

10. The information processing apparatus according to claim 2,
wherein, in a case where the target after being operated is included in another target, the deformation unit temporarily deforms a display image indicating another target.

11. The information processing apparatus according to claim 1,
wherein, in a case where a first operation is performed on the target by the user, and then a predefined second operation is detected, the deformation unit temporarily deforms a display image indicating the target in the first operation in response to the first operation.

12. The information processing apparatus according to claim 2,
wherein, in a case where a first operation is performed on the target by the user, and then a predefined second operation is detected, the deformation unit temporarily deforms a display image indicating the target in the first operation in response to the first operation.

13. The information processing apparatus according to claim 1, further comprising:
a presentation unit that presents an operation performed on the target in a case where a predefined third operation on the display image indicating the target is detected.

14. The information processing apparatus according to claim 2, further comprising:
a presentation unit that presents an operation performed on the target in a case where a predefined third operation on the display image indicating the target is detected.

15. The information processing apparatus according to claim 13,
wherein the presentation unit presents a content of another target included in the target before being operated.

16. The information processing apparatus according to claim 14,
wherein the presentation unit presents a content of another target included in the target before being operated.

17. The information processing apparatus according to claim 1,
wherein the deformation unit deforms a display image according to the type of the operation.

18. The information processing apparatus according to claim 17,
wherein, in a case where the type of the operation is a movement operation, the deformation unit adds an image correlating a display image of a movement source with a display image of a movement destination.

19. A non-transitory computer readable medium storing an information processing program causing a computer to function as:
a deformation unit that temporarily deforms a display image indicating a target in response to an operation in a case where a user performs the operation on the target,
wherein, in a case where the operation is an operation of moving, copying, or deleting the target from a location where the target is originally present on a screen, the deformation unit deforms the display image indicating the target before being operated in a state in which the target remains.

20. A non-transitory computer readable medium storing an information processing program causing a computer to function as:
a deformation unit that temporarily deforms a display image indicating a target in response to an operation in a case where a user performs the operation on the target,
wherein, in a case where the operation is a movement or copying operation, the deformation unit deforms a display image indicating a target of a movement destination or a display image indicating a target of a copying destination.
